(19) United States
(12) Patent Application Publication
(10) Pub. No.: US 2016/0162144 A1
(43) Pub. Date: Jun. 9, 2016

(54) DISPLAY DEVICE, DISPLAY METHOD AND COMPUTER READABLE NON-VOLATILE RECORDING MEDIUM STORING PROGRAM

(71) Applicant: CASIO COMPUTER CO., LTD., Tokyo (JP)

(72) Inventor: Takahiko RACHI, Tokyo (JP)

(73) Assignee: CASIO COMPUTER CO., LTD., Tokyo (JP)

(21) Appl. No.: 14/959,545

(22) Filed: Dec. 4, 2015

(30) Foreign Application Priority Data
Dec. 5, 2014 (JP) 2014-246391
Nov. 17, 2015 (JP) 2015-224383

(51) Int. Cl. G06F 3/0485; G06F 3/0483; G06F 3/041

(52) U.S. Cl. CPC G06F 3/0485; G06F 3/0412; G06F 3/0416; G06F 3/0483

(57) ABSTRACT

A display device, including: a display section; a detection section which detects an operation to instruct scrolling of a display content which is displayed on the display section; and a display control section which controls the display section to scroll the display content which is displayed on the display section when the detection section detects the operation, wherein the display control section performs first identification display at a position corresponding to a relative position of a start position of the operation with respect to the display content.

### CROSS-REFERENCE TO RELATED APPLICATIONS

The entire disclosures of Japanese Patent Application No. 2014-246391 filed on Dec. 5, 2014 and Japanese Patent Application No. 2015-224383 filed on Nov. 17, 2015 including descriptions, claims, drawings, and abstracts are incorporated herein by reference in its entirety.

### BACKGROUND OF THE INVENTION

1. Field of the Invention

The present invention relates to a display device, a display method and a computer readable non-volatile recording medium storing a program.

2. Description of Related Art

Conventionally, there have been known display devices called electronic papers as described in Japanese Patent Application Laid Open Publication No. 2013-29846, for example. Each of the devices has a non-luminescent display which does not become luminescent by itself.

However, in general electronic papers, it is difficult to smoothly change the display contents on screens in accordance with scroll operations due to the poor responsiveness of screen switching. Even in other display devices in addition to the electronic papers, the user performs scroll operation while grasping the position of display content where the user finished reading. However, there have been cases in which the user has lost the position where the user finished reading after the scroll operation ends.

### SUMMARY OF THE INVENTION

According to one aspect of the present invention, there is provided a display device, including: a display section; a detection section which detects an operation to instruct scrolling of a display content which is displayed on the display section; and a display control section which controls the display section to scroll the display content which is displayed on the display section when the detection section detects the operation, wherein the display control section performs first identification display at a position corresponding to a relative position of a start position of the operation with respect to the display content.

According to another aspect of the present invention, there is provided a display method, including: detecting an operation to instruct scrolling of a display content which is displayed on a display section; and controlling the display section to scroll the display content which is displayed on the display section when the operation is detected by the detecting, wherein the controlling includes performing first identification display at a position corresponding to a relative position of a start position of the operation with respect to the display content.

According to another aspect of the present invention, there is provided a computer readable non-volatile recording medium storing an executable program which is read by a computer to make a control section of a display device which includes a display section execute: detecting an operation to instruct scrolling of a display content which is displayed on the display section; and controlling the display section to scroll the display content which is displayed on the display section when the operation is detected by the detecting, wherein the controlling includes performing first identification display at a position corresponding to a relative position of a start position of the operation with respect to the display content.

### BRIEF DESCRIPTION OF THE DRAWINGS

The above and other objects, advantages and features of the present invention will become more fully understood from the detailed description given hereinafter and the appended drawings which are given by way of illustration only, and thus are not intended as a definition of the limits of the present invention, and wherein:

FIG. 1 is a plan view showing a schematic configuration of an electronic book reader in a first embodiment;

FIG. 2 is a block diagram showing a functional configuration of the electronic book reader in the first embodiment;

FIG. 3 is a flowchart showing the flow of electronic book display processing in the first embodiment;

FIG. 4 is an explanation view showing a display content when the electronic book display processing is performed in the first embodiment;

FIG. 5 is an explanation view showing a display content when the electronic book display processing is performed in the first embodiment;

FIG. 6 is an explanation view showing a display content when the electronic book display processing is performed in the first embodiment;

FIG. 7 is an explanation view showing a display content when the electronic book display processing is performed in the first embodiment;

FIG. 8 is an explanation view showing a display content when the electronic book display processing is performed in the first embodiment;

FIG. 9 is an explanation view showing a display content when the electronic book display processing is performed in the first embodiment;

FIG. 10 is an explanation view showing a display content when the electronic book display processing is performed in the first embodiment;

FIG. 11 is a plan view showing a schematic configuration of a personal computer in a second embodiment;

FIG. 12 is a block diagram showing a functional configuration of the personal computer in the second embodiment;

FIG. 13 is an explanation view showing a display content when the electronic book display processing is performed in the second embodiment;

FIG. 14 is an explanation view showing a display content when the electronic book display processing is performed in the second embodiment;

FIG. 15 is an explanation view showing a display content when the electronic book display processing is performed in the second embodiment; and

FIG. 16 is an explanation view showing a display content when the electronic book display processing is performed in the second embodiment.

### DETAILED DESCRIPTION OF THE PREFERRED EMBODIMENT

Hereinafter, an example of a first embodiment will be described in detail with reference to the accompanying drawings as for a case where a display device according to the present invention is applied to an electronic book reader. However, the scope of the present invention is not limited to the illustrated examples.

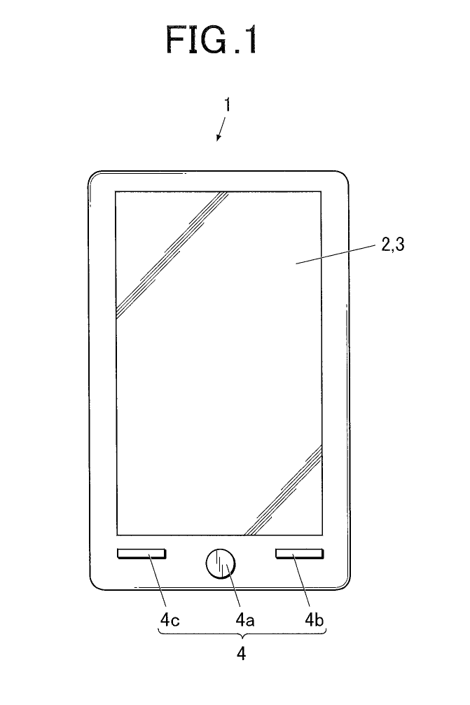

FIG. 1 is a plan view of an electronic book reader 1.

As shown in FIG. 1, the electronic book reader 1 includes a display section 2, a touch panel 3 and a key group 4.

The display section 2 displays various types of data (electronic book content data) corresponding to the operation to the key group 4 and the input surface of the touch panel 3 by the user, and is configured by including what is called electronic paper and such like.

The touch panel 3 is overlaid on the display section 2 and outputs a signal corresponding to the position touched by the user.

The key group 4 includes various keys which receive operations for operating the electronic book reader 1 from the user. Specifically, the key group 4 includes a menu button 4a, a right turn button 4b and a left turn button 4c.

The menu button 4a is a key used when the menu screen is switched between display and non-display. The menu screen includes a selection field of electronic book content data, a display end field of the electronic book content data, and such like.

The right turn button 4b is used when a page of the electronic book displayed on the display section 2 is turned to the right.

The left turn button 4c is used when a page of the electronic book displayed on the display section 2 is turned to the left.

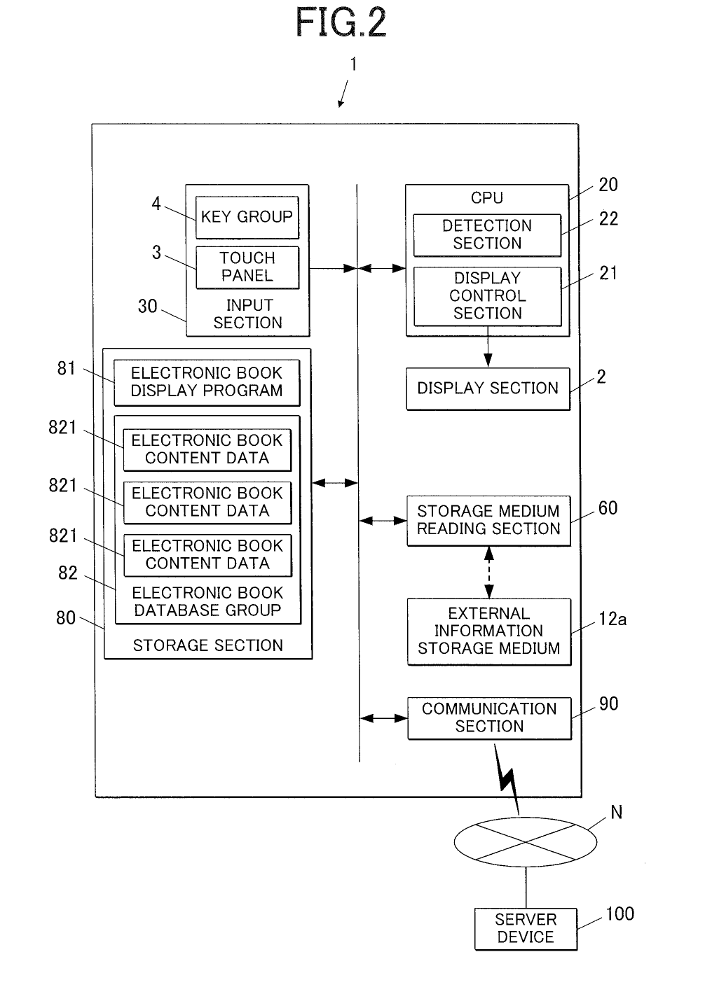

The internal configuration of the electronic book reader 1 will be described. FIG. 2 is a block diagram showing the internal configuration of the electronic book reader 1.

As shown in FIG. 2, the electronic book reader 1 includes the display section 2, an input section 30, a storage medium reading section 60, a CPU (Central Processing Unit) 20, a storage section 80 and a communication section 90. The sections are connected to each other so as to communicate data via bus.

The CPU 20 functions as a display control section 21 which controls the display section 2 to display various types of information by transmitting a display control signal to the display section 2.

The input section 30 includes the above-mentioned key group 4 and the touch panel 3, and outputs a signal corresponding to the pressed key or the position inside the input surface of touch panel 3 to the CPU 20.

The storage medium reading section 60 reads out information from an external information storage medium 12a which is set in a card slot (not shown in the drawings), and records information in the external information storage medium 12a. Here, electronic book content data and such like are stored in the external information storage medium 12a.

In accordance with the input instruction, the CPU 20 executes processing based on a program which was stored in the storage section 80 in advance, performs instruction to the function sections, data transfer and such like, and integrally controls the electronic book reader 1. Specifically, the CPU 20 reads out various programs stored in the storage section 80 according to the operation signal input from the input section 30, and executes the processing according to the program. The CPU 20 functions as a storage control section which stores a processing result in the storage section 80, and the CPU 20 also functions as a display control section 21 which controls the display section 2 to appropriately output the processing result.

The storage section 80 is a memory which stores programs and data for achieving the various functions of the electronic book reader 1, and functions as a working area of the CPU 20. In the first embodiment, the storage section 80 stores an electronic book display program 81 as a program according to the present invention and an electronic book database group 82.

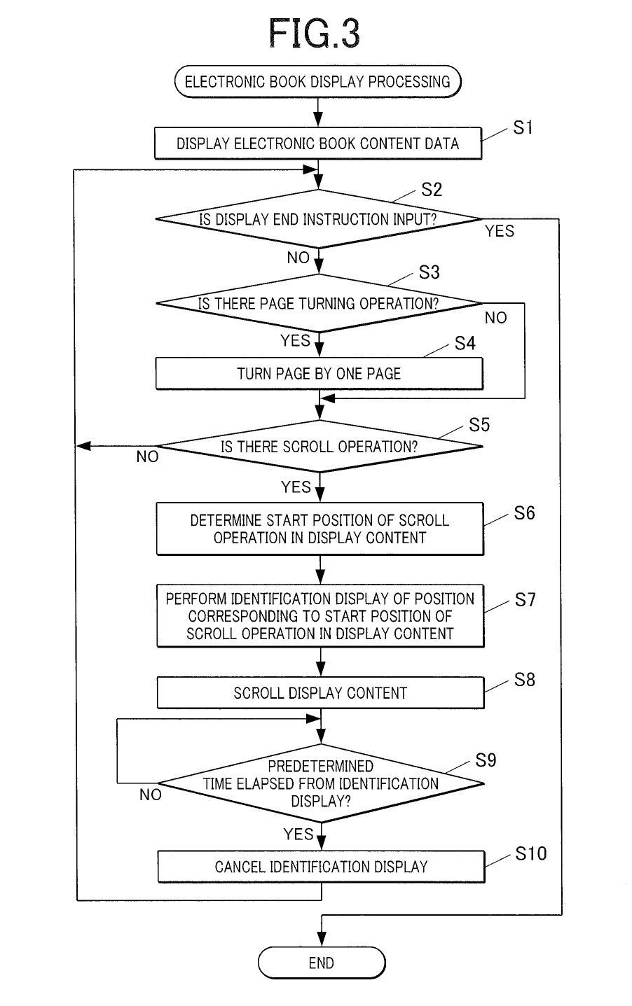

The electronic book display program 81 is a program for making the CPU 20 function as the display control section 21 by making the CPU 20 executing after-mentioned scroll processing (see FIG. 3).

The electronic book database group 82 includes a plurality of types of different electronic book content data 821. The electronic book content data 821 is electronic data of a book and contains text data and image data, for example.

The communication section 90 can communicate with an external server device 100 via a line such as an internet N in a wired or wireless manner, for example. The communication section 90 reads out information from the server device 100 and transmits information to the server device 100.

Next, operations of the electronic book reader 1 will be described with reference to the drawings.

FIG. 3 is a flowchart showing the flow of electronic book display processing executed by reading out the electronic book display program 81 when the CPU 20 functions as the display control section 21.

When the CPU 20 executes the electronic book display program 81, electronic book display processing is started.

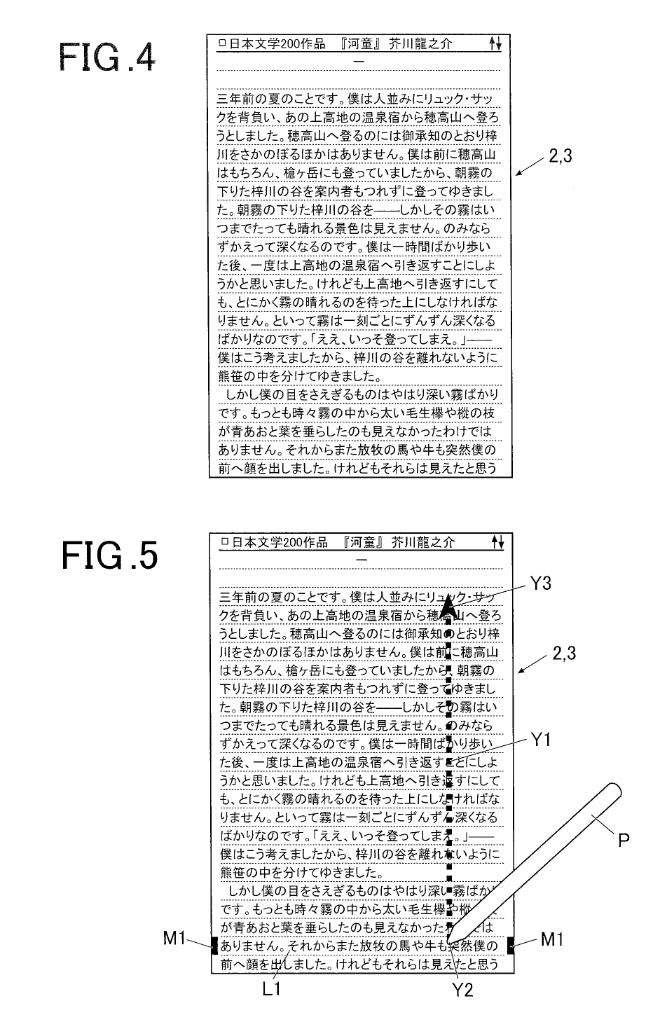

In step S1, the CPU 20 reads out the electronic book content data 821 selected by the user from the electronic book database group 82, and displays the data on the display section 2. FIG. 4 is an explanation view showing a part of the electronic book displayed on the display section 2. As shown in FIG. 4, the display section 2 does not display a mark showing a position in a character string, or what is called a character cursor. However, such character cursor may be displayed, if necessary.

In step S2, the CPU 20 determines whether the display end instruction of the electronic book content data is input. If the display end instruction is input, the electronic book display processing ends, and if the display end instruction is not input, the processing proceeds to step S3.

In step S3, the CPU 20 determines whether a page turning operation was performed by operating the right turn button 4b or the left turn button 4c. If the page turning operation was performed, the processing proceeds to step S4, and if the page turning operation was not performed, the processing proceeds to step S5.

In step S4, the CPU 20 controls the display section 2 to switch the display content so as to turn one page of the electronic book displayed on the display section 2. Specifically, if the right turn button 4b was operated in step S3, the page of the electronic book is turned to the right, and if the left turn button 4c was operated in step S3, the page of the electronic book is turned to the left.

In step S5, the CPU 20 determines whether a scroll operation was performed. If the scroll operation was performed, the processing proceeds to step S6. If the scroll operation was not performed, the processing proceeds to step S2.

Here, the scroll operation is an operation for moving the display content of the display section 2 forward or backward. Specifically, as shown in FIG. 5, the scroll operation is a series of operations that are making a stylus P (or a finger) contact the input surface of the touch panel 3 (touch on operation), making the stylus P slide on the touch panel 3 by a desired amount while contacting the input surface (slide operation), and moving the stylus P away from the input surface of the touch panel 3 (touch off operation). The CPU 20 acquires an input signal from the touch panel 3 at predetermined time intervals, and detects the input status of the touch panel 3 (whether or not the input surface is contacted, and the coordinate of the contacted position) on the basis of the acquired input signal. The CPU 20 detects each operation of the touch on, slide and touch off on the basis of the change over time in the detected input status. Thus, the CPU 20 functions as the detection section 22.

In FIG. 5, the base end of the arrow Y1 is a start position Y2 of the scroll operation, that is, the position where the touch on operation was performed on the input surface of touch panel 3. The distal end of the arrow Y1 is the end position Y3 of the scroll operation, that is, the position where the touch off operation was performed on the input surface of touch panel 3. In other words, here, an XY plane has the origin at the upper left vertex of the rectangular input surface of the touch panel 3 shown in FIG. 5, the X axis in the horizontal direction and the Y axis in the vertical direction of FIG. 5. Then, the position on the input surface of the touch panel 3 where the touch on operation was performed when the scroll operation was started is the start position Y2 (coordinate (X₁, Y₁)), and the position on the input surface of the touch panel 3 where the touch off operation was performed when the scroll operation was finished is the end position Y3 (coordinate (X₂, Y₂)). Ina case where the above-mentioned character cursor is displayed, the start position Y2 is the position which is arbitrarily specified by the user regardless of the display position of character cursor each time the scroll operation is performed.

In step S6, on the basis of the input signal from the touch panel 3, the CPU 20 detects the XY coordinate of the above-mentioned start position Y2, that is, the position on the input surface of the touch panel 3 where the touch on operation was performed when the scroll operation is started. Thus, the CPU 20 functions as the detection section 22. Then, the processing by the CPU 20 proceeds to step S7.

In step S7, the CPU 20 identifies the line L1 of the text displayed at the start position Y2, and determines the positions of both end portions of the line L1 to display marks M1. Next, as shown in FIG. 5, the CPU 20 controls the display section 2 to provide the marks M1 (first identification display) for making the line L1 conspicuous to the respective determined positions of both end portions of the line L1 before starting the scroll of the display content. This identification display is performed at the positions corresponding to the relative position of start position Y2 of scroll operation with respect to the display content. Thus, the CPU 20 functions as the display control section 21. When the identification display is performed, the display content is not scrolled yet. Thus, FIG. 5 is different from FIG. 4 only in that the marks M1 are provided to the both end portions of the line L1.

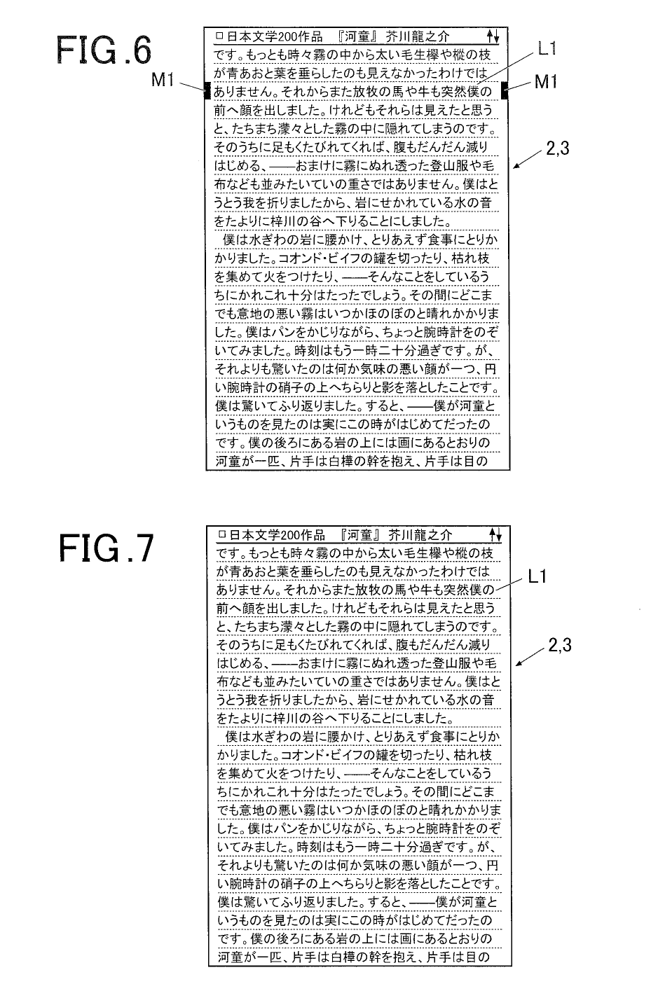

In step S8, as shown in FIG. 6, the CPU 20 controls the display section 2 to scroll the display content so that the line L1 and the marks M1 move to the end position Y3 of the scroll operation. As mentioned above, since the identification display is performed at the positions corresponding to the relative position of the start position Y2 of scroll operation with respect to the display content, the relative positions of the marks M1 with respect to the display content are not changed. Accordingly, the marks M1 are still displayed at the both end portions of the line L1 after the end of scrolling of the display content. Thus, the CPU 20 functions as the display control section 21. The scrolling of display content indicates that, after the CPU 20 detects the start of slide operation, on the basis of the slide operation, the CPU 20 controls the display section 2 to update the display of the display content on the display section 2, which was displayed on the display section 2 before the slide operation was started (at the touch on operation), by shifting the display content in a direction corresponding to the slide direction by an amount corresponding to the slide amount for which the stylus P has slid until the timing when the display is updated. The update of display may be performed at an arbitrary timing after the CPU 20 detects the start of slide operation. Accordingly, the CPU 20 may scroll the display content by updating the display after the end of the scroll operation, that is, when or after the touch off operation is detected, or the CPU 20 may scroll the display content by updating the display while the scroll operation is being performed, that is, during the slide operation of the scroll operation (before detection of the touch off operation).

In step S9, the CPU 20 determines whether a predetermined time has elapsed from the start of identification display. Thus, the CPU 20 functions as the detection section 22. If the detection section 22 detects that the predetermined time has not elapsed, the CPU 20 maintains the processing, and if the CPU 20 detects that the predetermined time has elapsed, the control by the CPU 20 proceeds to step S10.

In step S10, the CPU 20 controls the display section 2 to set the identification display to non-display (not to be displayed) by deleting the marks M1 as shown in FIG. 7, and then proceeds to step S2.

The CPU 20 functions as the display control section 21 by executing the above-mentioned steps to control the display section 2.

As in a case of electronic paper applied to the electronic book reader 1 in the first embodiment, the display is not updated during the slide operation in some display devices which have low responsiveness of display update with respect to the scroll operation. In such display devices, when the display content as shown in FIG. 5 is updated as the scrolling of the display content, the display suddenly changes to the display as shown in FIG. 6. Thus, there has been a problem that the user cannot easily grasp the start position of scroll operation and the scroll amount of display content.

However, according to the first embodiment, when the scroll operation is detected by the CPU 20, the marks M1 are displayed at the positions corresponding to the relative position of the start position of scroll operation with respect to the display content. Thus, the user can easily grasp the start position of scroll operation and the scroll amount of display content.

When a text is displayed on the display section 2, the identification display is performed at the line L1 in the text corresponding to the start position Y2 of the scroll operation. Thus, the user can grasp the line of the position where the user has finished the reading before the scrolling.

It is possible to make the line L1 conspicuous by simple processing since the marks M1 are provided to the line L1 in the text corresponding to the start position Y2.

When the scroll operation is finished, the identification display is performed at the positions of display content corresponding to the start position Y2. Thus, it is possible to reduce the number of screen changes by identification display even compared with the case of performing identification display during the scroll operation. Specifically, in a case where the identification display is performed during the scroll operation, the identification display is performed when the first touch operation is performed, and the identification display is also performed after the scroll operation. Thus, the screen is changed twice. On the other hand, in a case where identification display is performed after the scroll operation is finished as in the first embodiment, the identification display is performed only at that time. Thus, the screen is changed once. As the number of screen changes is smaller, the power consumption can be suppressed more.

When the CPU 20 (detection section 22) detects that the predetermined time has elapsed from the start of identification display, the display control section 21 sets the identification display to non-display. Thus, the identification display is not continued and it is possible to prevent the identification display from being an eyesore.

The display control section 21 may perform the processing of setting the identification display to non-display when a predetermined operation is detected by the detection section 22. The predetermined operation may be an operation of pressing a physical button included in the input section 4 of the electronic book reader 1, or may be a touch operation to a position on the touch panel 3 corresponding to a virtual button which is displayed on the display section 2 and provided by software.

The embodiment to which the present invention can be applied is not limited to the above-mentioned embodiment, and changes can be appropriately made within the scope of the present invention.

In the first embodiment, the identification display is performed before the scrolling of display content is started (step S7), and the identification display is also performed after the scrolling of display content is finished (step S8). However, the present invention is not limited to this, and the identification display may not be performed before the scrolling is started and may be performed for the first time after the scrolling is finished. The CPU 20 as the display control section 21 may control the display section 2 to display the marks M1 at least after the end of scrolling. Thus, similarly to the first embodiment, the user can easily grasp the start position of scroll operation and the scroll amount of display content.

The first embodiment has been described by taking, as an example, a case where a text of horizontal writing is scrolled vertically; however, the configuration of the present invention can also be applied to a case where a text of vertical writing is scrolled horizontally.

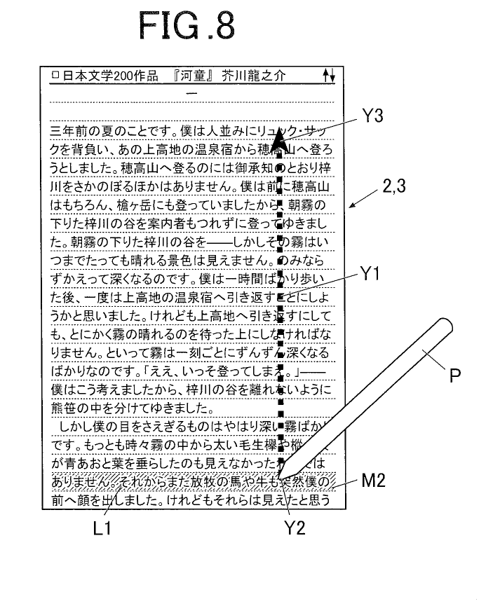

The first embodiment has been described by taking, as an example, a case where the marks M1 are provided to the line L1 as the identification display; however, the identification display may be anything as long as the line L1 can be clearly distinguished from the other portion. For example, as shown in FIG. 8, a marker M2 may be provided to the line L1 corresponding to the start position Y2 of the scroll operation. The marker M2 may have a manner of changing the background color of all or a part of the line L1 as in FIG. 8, a manner of changing both the character color and the background color of all or a part of the line L1, a manner of changing the character string of all or a part of the line L1 to be bold, or a manner of changing the contrast (for example, increasing the contrast) between the character color of the character string and the background color of all or a part of the line L1. It goes without saying that these manners can be appropriately combined with each other and the marker M2 may have a manner not described here as long as it can obtain a visual effect.

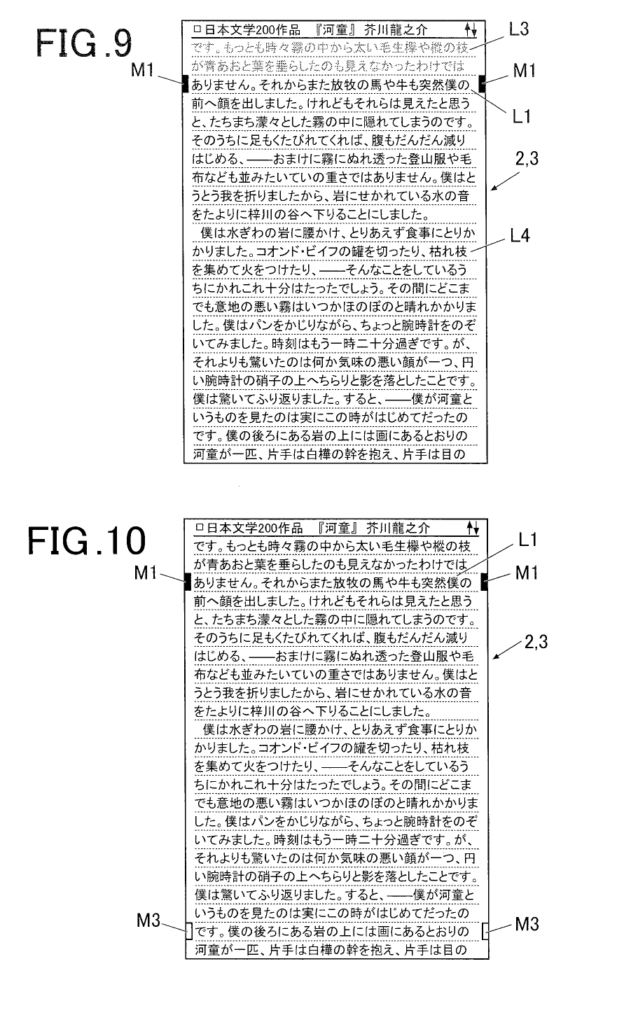

The identification display may also be performed by visually differentiating the read part from the unread part, the read part being determined to be a preceding portion of the line L1 corresponding to the start position Y2, that is, the portion including the line immediate before the line L1 and its preceding lines, and the unread part being determined to be a subsequent portion of the line L1, that is, the portion including the line L1 and its subsequent lines. Specifically, as shown in FIG. 9, the display may be changed so that the contrast between the character color and the background color of the preceding portion L3 is different from the contrast between the character color and the background color of the subsequent portion L4 (for example, the contrast of the preceding portion L3 may be changed to be smaller than the contrast of the subsequent portion L4).

As shown in FIG. 10, the CPU 20 as the display control section 21 may control the display section 2 to perform identification display at the positions corresponding to the relative position of the start position Y2 of scroll operation with respect to the display section 2 after the scrolling of display content is finished. Specifically, as shown in FIG. 10, after the scrolling of display content is finished, marks M3 (second identification display) for making the line L2 conspicuous may be provided to the both end portions of the line L2 in the text displayed at the start position Y2. The marks M3 may have a form similar to or different from that of the above-mentioned marks M1. Thus, the user can easily grasp the start position of scroll operation and the scroll amount of display content similarly to the above-mentioned first embodiment.

In the first embodiment, at least one of the marks M1 and M2 is displayed both before the start of scrolling and after the end of scrolling; however, the present invention is not limited to this, and at least one of the marks M1 and M2 may be displayed only after the end of scrolling without being displayed before start of the scrolling, or may be displayed at an arbitrary timing after the start of scrolling. Especially, in a case where the display device has a display section 2 with high responsiveness to the display change operation, it is possible to make the user easily grasp the start position of scroll operation and the scroll amount of display content by providing at least one of the marks M1 and M2 not only after the end of scrolling but also after the start of scrolling, that is, at an arbitrary timing during and after the scrolling.

In the first embodiment, the marks M3 are displayed after the end of the scrolling; however, the present invention is not limited to this. The marks M3 may be displayed at an arbitrary timing after the start of scrolling. Thereby, the user can easily grasp the start position of scroll operation and the scroll amount of display content.

In any one of the above cases, the same processing may be executed on the basis of the end position Y3, not the start position Y2.

The scroll operation has been described as an operation of touching the touch panel 3 with the stylus P (or a finger), making the stylus P slide in the direction to forward the display content on the touch panel 3 while touching the touch panel 3, and releasing the stylus P from the touch panel 3 at the position corresponding to the desired amount; however, the present invention is not limited to this. The scrolling may be performed by what is called a flick operation of slightly flicking the touch panel 3 with the stylus P (or a finger). In a case where the display content is scrolled on the basis of the flick operation, the end position Y3 is appropriately determined according to the movement distance, movement speed and such like of stylus P moving on the input surface of touch panel 3 by the flick operation.

In the first embodiment, the display section 2 is electronic paper; however, the display section may be configured by including an LCD (Liquid Crystal Display), an ELD (Electronic Luminescence Display) and such like.

The display device according to the present invention has been described as the electronic book reader 1; however, the product to which the present invention can be applied is not limited to this. The present invention can be applied to the overall electronic devices such as mobile phone, personal computer, PDA (Personal Digital Assistant) and game machine.

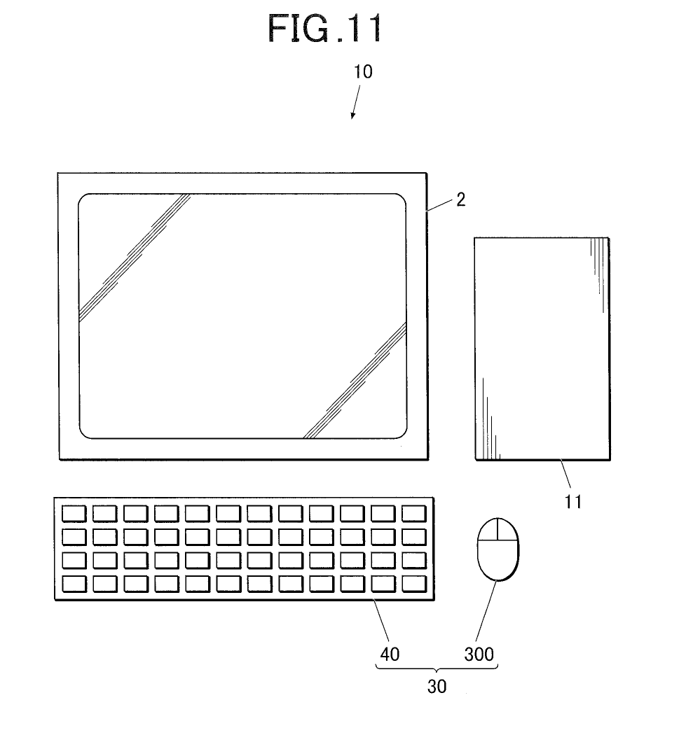

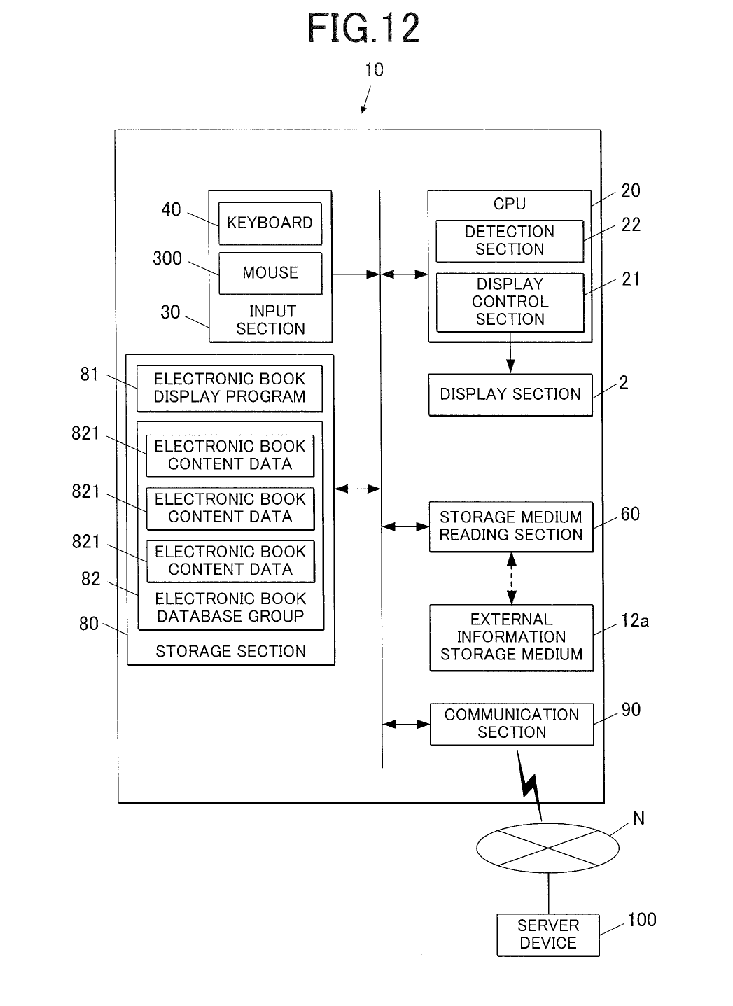

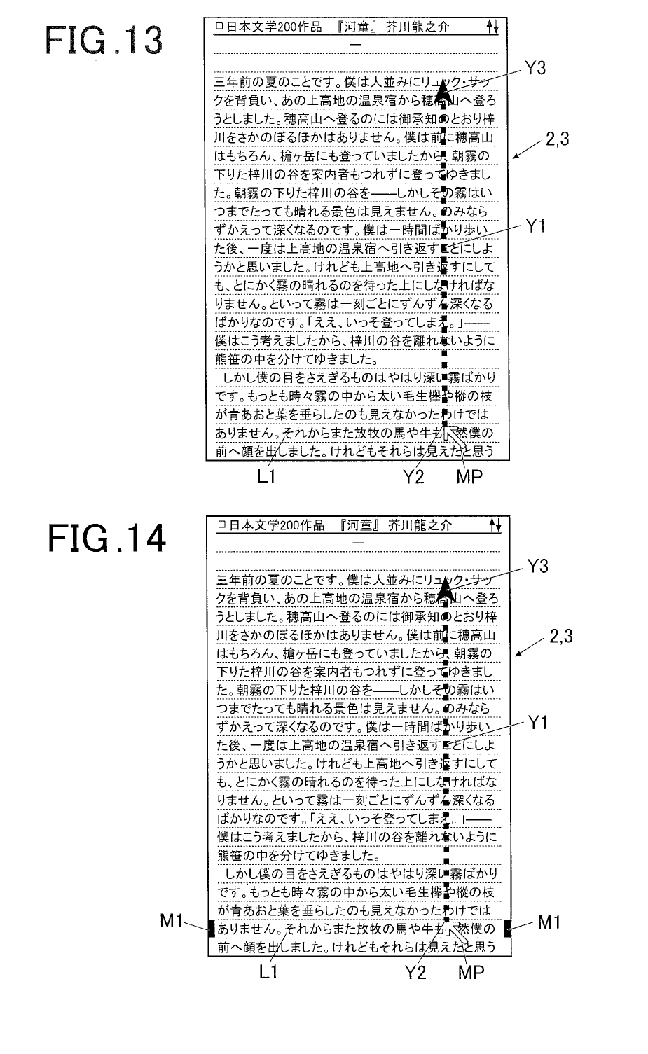

Hereinafter, a second embodiment in a case of applying the present invention to a personal computer will be described by using FIGS. 11 to 16. FIG. 11 is a schematic configuration view showing the configuration of a personal computer 10 in the second embodiment. FIG. 12 is a block diagram showing a functional configuration of the personal computer 10 in the second embodiment. FIGS. 13 to 16 are explanation views showing display contents when electronic book display processing of the second embodiment is performed. As for the second embodiment, same reference numerals are provided to the same configurations as those of the above-mentioned electronic book reader 1 to omit the explanation thereof, and the other different configurations will be mainly described. Since the flowchart showing the flow of electronic book display processing is similar to that of FIG. 3, the description will be made by referring to FIG. 3 as needed.

As shown in FIGS. 11 and 12, the input section 30 of the personal computer 10 in the second embodiment includes a keyboard 40 and a mouse 300. The CPU 20, storage medium reading section 60, storage section 80 and communication section 90 shown in FIG. 12 are set in the housing of personal computer main body 11 shown in FIG. 11. As shown in FIG. 12, the input section 30 outputs, to the CPU 20, an input signal corresponding to a pressed key, a pointer position of the mouse 300, and various operations such as movement, click and wheel rotation of the mouse 300. The CPU 20 functions as the display control section 21 which controls the display section 2 to display various information by transmitting a display control signal to the display section 2 such as LCD display on the basis of the input signal from the input section 30.

In step S1 shown in FIG. 3, the display section 2 performs the same display as that of FIG. 4 by the control of display control section 21. In this case, the mouse pointer MP of mouse 300 is not shown in the drawing since it is located outside the window of electronic book.

FIG. 13 is a view showing a display content on the display section 2 when it is determined whether the scroll operation was performed in step S5 of FIG. 3. First, before the scroll operation is performed, as shown in FIG. 13, the mouse pointer MP is located at a position overlapping the line L1 in the window of electronic book by the user's movement operation of mouse 300. In this state, when the wheel of mouse 300 is rotated by the user's operation, the CPU 20 detects the start of rotation operation of wheel on the basis of the input signal from the mouse 300, and after a while, the CPU 20 detects the end of rotation operation of the wheel. Thus, the CPU 20 functions as the detection section 22 which detects the wheel rotation of mouse 300. When the CPU 20 detects the wheel rotation of mouse 300, the processing by the CPU 20 proceeds to step S6.

In step S6, the CPU 20 detects the start position Y2 of scroll operation on the basis of the input signal from the mouse 300. Specifically, when the CPU 20 detects the wheel rotation of mouse 300 on the basis of the input signal from the mouse 300 in a state in which the mouse pointer MP is located inside the window of electronic book, the CPU 20 detects the XY coordinate of the position where the mouse pointer MP was displayed on the display section 2 at this time. Thus, the CPU 20 functions as the detection section 22. Subsequently, the CPU 20 executes the processing of step S7.

The processing of step S7 is similar to that of the first embodiment. FIG. 14 shows the display within the window of electronic book when the processing of step S7 was finished. Since the display content is not scrolled yet when the identification display is performed in step S7, FIG. 14 is different from FIG. 13 only in that the marks M1 are provided to the both end portions of the line L1, similarly to the first embodiment. Thus, the CPU 20 functions as the display control section 21.

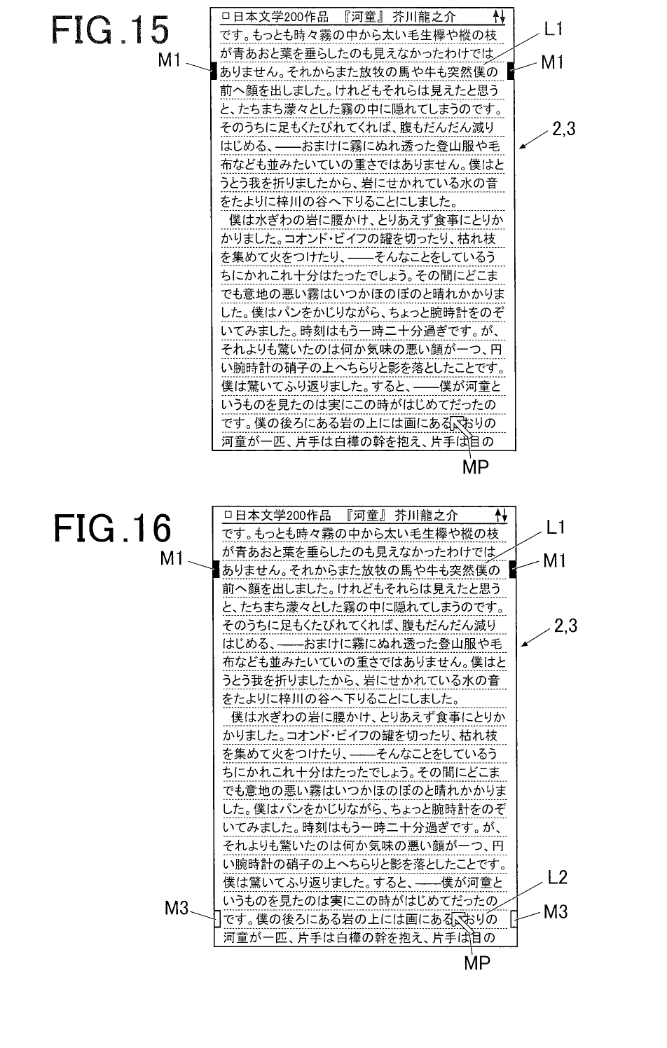

In step S8, the CPU 20 controls the display section 2 to scroll the display content so as to move the line L1 and the marks M1 to the end position Y3 of the scroll operation as shown in FIG. 15. The end position Y3 is appropriately determined according to the rotation amount and rotation speed of the wheel rotation operation. The display control section 21 vertically moves the display content inside the window displayed on the display section 2 on the basis of the scroll operation whereas the mouse pointer MP is not moved and the position thereof remains as in FIG. 14.

Similarly to the first embodiment, since the identification display is provided to the positions corresponding to the relative position of the start position Y2 of scroll operation with respect to the display content, the relative positions of marks M1 with respect to the display content are not changed. Accordingly, the marks M1 are displayed at the both end portions of line L1 even after the end of scrolling of display content. Thus, the CPU 20 functions as the display control section 21. In the second embodiment, the scrolling of display content indicates the operation performed after the CPU 20 detects the start of wheel rotation operation, the operation being making the display section 2 update the display on the basis of the wheel rotation operation by shifting the display content, which was displayed on the display section 2 before the wheel rotation operation was started, in a predetermined scroll direction (vertical direction) by the amount corresponding to the wheel rotation amount for which the wheel was rotated at the timing of updating the display. The update of display may be performed at an arbitrary timing after the CPU 20 detects the start of wheel rotation operation. Accordingly, the CPU 20 may perform scrolling of display content by updating the display when or after the wheel rotation operation is finished, or by updating the display during the wheel rotation operation.

The processing of steps S9 and S10 is similar to that of the above-mentioned embodiment.

The CPU 20 functions as the display control section 21 by executing the above steps and controlling the display section 2.

In the second embodiment, similarly to the above-mentioned embodiment, as shown in FIG. 13, the display section 2 does not display a mark showing a position in the character string, what is called a character cursor; however, such character cursor may be displayed if necessary. In a case of displaying the character cursor, the start position Y2 is arbitrarily specified by the user regardless of the display position of the character cursor each time the scroll operation is performed.

In the second embodiment, in a state in which the mouse pointer MP is located inside the window of electronic book content data 821 on the display screen of display section 2, the electronic book content data 821 may be moved forward in the display region by rotating the wheel of mouse 300 in one direction and the electronic book content data 821 may be moved backward in the display region by rotating the wheel in the other direction.

In the second embodiment, similarly to the above embodiment, as shown in FIG. 16, the CPU 20 as the display control section 21 may control the display section 2 to provide the identification display at the positions corresponding to the relative position of start position Y2 of scroll operation with respect to the display section 2 after the scrolling of display content is finished. Specifically, as shown in FIG. 16, after the scrolling of display content is finished, marks M3 (second identification display) for making the line L2 conspicuous may be provided to the both end portions of line L2 in the text displayed at the start position Y2. The marks M3 may have the same form as that of the above marks M1, or may have different forms.

It goes without saying that the same effect can be obtained even in the second embodiment when the second embodiment includes the same configuration as that of the first embodiment, and furthermore, above-mentioned modification examples can also be applied.

Though several embodiments of the present invention have been described above, the scope of the present invention is not limited to the above embodiments, and includes the scope of inventions, which is described in the scope of claims, and the scope equivalent thereof.

What is claimed is:

1. A display device, comprising:
a display section;
a detection section which detects an operation to instruct scrolling of a display content which is displayed on the display section; and
a display control section which controls the display section to scroll the display content which is displayed on the display section when the detection section detects the operation, wherein
the display control section performs first identification display at a position corresponding to a relative position of a start position of the operation with respect to the display content.

2. The display device according to claim 1, wherein
the detection section detects the start position of the operation, and
the display control section performs the first identification display based on the start position of the operation detected by the detection section.

3. The display device according to claim 1, wherein the display control section performs the first identification display after the scrolling of the display content is started.

4. The display device according to claim 1, wherein the display control section performs the first identification display after the scrolling of the display content is finished.

5. The display device according to claim 1, wherein the display control section performs the first identification display before the scrolling of the display content is started.

6. The display device according to claim 1, wherein the display control section performs the first identification display before the scrolling of the display content is started and after the scrolling of the display content is finished.

7. The display device according to claim 1, wherein the display control section performs second identification display at a position corresponding to a relative position of the start position of the operation with respect to the display section after the scrolling of the display content is finished.

8. The display device according to claim 1, wherein, in a case where a text is displayed on the display section, the display control section performs the first identification display at a line in the text corresponding to the relative position of the start position of the operation with respect to the display content.

9. The display device according to claim 8, wherein the display control section performs, as the first identification display, at least one of:
(1) providing a mark to at least one of ends of the line in the text;
(2) changing a contrast between a character color and a background color of a character string included in the line in the text; and
(3) changing a contrast between a character color and a background color of a preceding portion preceding the line in the text to be different from a contrast between a character color and a background color of a subsequent portion including and following the line.

10. The display device according to claim 1, wherein the display control section sets the first identification display not to be displayed when the detection section detects that a predetermined time has elapsed from start of the first identification display or a predetermined operation is input.

11. A display method, comprising:
detecting an operation to instruct scrolling of a display content which is displayed on a display section; and
controlling the display section to scroll the display content which is displayed on the display section when the operation is detected by the detecting, wherein
the controlling includes performing first identification display at a position corresponding to a relative position of a start position of the operation with respect to the display content.

12. The display method according to claim 11, wherein
the detecting includes detecting the start position of the operation, and
the controlling includes performing the first identification display based on the start position of the operation detected by the detecting.

13. The display method according to claim 11, wherein the controlling includes performing the first identification display after the scrolling of the display content is started.

14. The display method according to claim 11, wherein the controlling includes performing the first identification display after the scrolling of the display content is finished.

15. The display method according to claim 11, wherein the controlling includes performing the first identification display before the scrolling of the display content is started.

16. The display method according to claim 11, wherein the controlling includes performing the first identification display before the scrolling of the display content is started and after the scrolling of the display content is finished.

17. The display method according to claim 11, wherein the controlling includes performing second identification display at a position corresponding to a relative position of the start position of the operation with respect to the display section after the scrolling of the display content is finished.

18. The display method according to claim 11, wherein, in a case where a text is displayed on the display section, the controlling includes performing the first identification display at a line in the text corresponding to the relative position of the start position of the operation with respect to the display content.

19. The display method according to claim 18, wherein the controlling includes performing, as the first identification display, at least one of:
(1) providing a mark to at least one of ends of the line in the text;
(2) changing a contrast between a character color and a background color of a character string included in the line in the text; and
(3) changing a contrast between a character color and a background color of a preceding portion preceding the line in the text to be different from a contrast between a character color and a background color of a subsequent portion including and following the line.

20. The display method according to claim 11, wherein the controlling includes setting the first identification display not to be displayed when elapse of a predetermined time from start of the first identification display or input of a predetermined operation is detected by the detecting.

21. A computer readable non-volatile recording medium storing an executable program which is read by a computer to make a control section of a display device which includes a display section execute:
detecting an operation to instruct scrolling of a display content which is displayed on the display section; and
controlling the display section to scroll the display content which is displayed on the display section when the operation is detected by the detecting, wherein
the controlling includes performing first identification display at a position corresponding to a relative position of a start position of the operation with respect to the display content.
